(19) United States
(12) Patent Application Publication
(10) Pub. No.: US 2018/0183069 A1
(43) Pub. Date: Jun. 28, 2018

(54) CATHODE FOR LITHIUM AIR BATTERY HAVING IMPROVED CAPACITY

(71) Applicants: Hyundai Motor Company, Seoul (KR); Kia Motors Corporation, Seoul (KR)

(72) Inventor: Kyoung Jin Jeong, Gangnam-gu (KR)

(73) Assignees: Hyundai Motor Company, Seoul (KR); Kia Motors Corporation, Seoul (KR)

(21) Appl. No.: 15/828,034

(22) Filed: Nov. 30, 2017

(30) Foreign Application Priority Data
Dec. 27, 2016 (KR) 10-2016-0179652

(51) Int. Cl. H01M 4/90; H01M 12/06

(52) U.S. Cl. CPC H01M 4/9083; H01M 10/052; H01M 12/06; H01M 4/9016

(57) ABSTRACT

A cathode for a lithium air battery may include a carbon foam having a net structure configured by a plurality of 3D open cells; an electrode material coated on a skeleton of the carbon foam and filled in the 3D open cells; and an air channel providing a space such that air introduced into the battery flows.

### CROSS-REFERENCE TO RELATED APPLICATION

The present application claims priority to Korean Patent Application No. 10-2016-0179652, filed on Dec. 27, 2016, the entire contents of which is incorporated herein for all purposes by this reference.

### BACKGROUND OF THE INVENTION

### Field of the Invention

The present invention relates to a cathode and a lithium air battery having improved battery capacity and an increased lifespan.

### Description of Related Art

Currently, we face several problems such as depletion of fossil fuels, environmental pollution, and global warming due to a rapid growth. As a solution to these problems, new renewable energy is being developed, but remarkable achievements have not yet been made. Accordingly, there is increased interest in energy storage technology, especially in a battery field.

As a result, in the field of lithium ion battery technology, remarkable development has been achieved. However, current lithium ion batteries are insufficient to replace fossil fuels due to low energy density.

Currently, metal air batteries, in particular lithium air batteries are being developed in countries such as the United States and Japan.

The lithium air battery uses oxygen which is limitlessly supplied from air as an active material. In principle, very high energy density may be obtained. The theoretical energy density of the lithium air battery is calculated to be about 3,200 Wh/kg which is about 10 times higher than that of a lithium ion battery. Furthermore, since oxygen is used as the active material, the lithium air battery has an advantage of being eco-friendly.

However, lithium air batteries as described in the prior art have a fatal disadvantage, specifically, a low discharge capacity and overvoltage due to high polarization. For example, when the battery is discharged, lithium peroxide (Li₂O₂) generated as a discharge product irregularly accumulates on the surface of the cathode. Since a porous material having a dense structure such as carbon fiber and carbon paper is used as the cathode, a discharge product is formed, the flow of oxygen is disturbed, and as a result, the actual performance of the battery deteriorates significantly compared with the theoretical performance.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a capacity of a battery by changing and designing a structure of a cathode for a lithium air battery.

Various aspects of the present invention are directed to providing a cathode for a lithium air battery capable of extending the capacity of the battery and the lifespan of the battery.

The objects of the present invention are not limited to the objects described above. The objects of the present invention will be more apparent in the description below and implemented by means described in the claims and a combination thereof.

Various aspects of the present invention are directed to providing a cathode for a lithium air battery comprising: a carbon foam having a net structure configured by a plurality of 3D open cells; an electrode material coated on a skeleton of the carbon foam and filled in the 3D open cells; and an air channel providing a space in which the air introduced into the battery is flowable.

In various exemplary embodiments, the carbon foam may have a pore per inch (PPI) value in a range of from about 10 PPI to about 100 PPI.

In other embodiments, the electrode material may include a carbon-based material selected from the group consisting of graphite, carbon black, ketjen black, acetylene black, carbon nano tube (CNT), reduced graphene oxide (rGO), and a combination thereof.

In another exemplary embodiment, the electrode material may further include a catalyst selected from the group consisting of MnO₂, Co₃O₄, Ru, Ir, RuO₂, Pd, Pt, Bi, Au, Pt₃Co, Ag, FeO, Ru-rGO, RuO₂-rGO, Ir-rGO, Pt₃Co-rGO, FeCo-CNT, FePt-CNT/rGO, RuCo-CNT/rGO, Pd—Ir core-shell nanotube, AgIr, AuIr, and a combination thereof.

In various exemplary embodiments, an amount of the electrode material may be about 20 mg/cm³ to about 60 mg/cm³.

In various exemplary embodiments, a size of the air channel may be about 127 μm to about 1,270 μm.

In other exemplary embodiments, a thickness of the cathode may be about 2 mm to about 6 mm.

Various aspects of the present invention are directed to providing a lithium air battery comprising the cathode described above, an anode; and an electrolyte impregnated in the cathode and the anode.

The present invention includes the above configurations and thus has the following effects.

According to an exemplary embodiment of the present invention, since the cathode has a 3D open cell structure, the cathode may have a dual pore structure of macro pores and micro pores. Also, since pores having predetermined sizes are evenly formed, a discharge product may be evenly formed on the surface of the cathode and inside the cathode. Accordingly, since the discharge product of the cathode may be more retained, the capacity of the battery is remarkably improved.

According to an exemplary embodiment of the present invention, even though the discharge product is formed, since the flow passage of the air is sufficiently ensured, oxygen can be used as an active material and an electrolyte may be easily penetrated up to the inside of the cathode. And thus, the capacity of the battery is more improved, enhanced, or increased and the lifespan of the battery is extended because overvoltage does not occur.

The effects of the present invention are not limited to the aforementioned effects. It should be understood that the effects of the present invention include all effects inferable from the description below.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, a vehicle that is both gasoline-powered and electric-powered.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a scanning electron microscope (SEM) analysis result for a carbon foam of a cathode for a lithium air battery according to an exemplary embodiment of the present invention, and particularly, an SEM analysis result for a carbon foam when the porosity is 10 PPI, 20 PPI, 30 PPI, 45 PPI, 80 PPI, and 100 PPI.

FIG. 2A is an SEM analysis result for a carbon paper used as a supporter of a cathode for a lithium air battery in the related art and FIG. 2B is an SEM analysis result for a carbon felt used as the supporter of the cathode for the lithium air battery in the related art.

FIG. 3A is an SEM analysis result for a carbon foam in Example 1, particularly, an SEM analysis result for a carbon foam before an electrode material is impregnated.

FIG. 3B is an SEM analysis result for a cathode after an electrode material is impregnated in the carbon foam in Example 1.

FIG. 3C is an SEM analysis result for enlarged FIG. 3B.

FIG. 4 is a photograph for a lithium air battery in Example 1.

FIG. 5 is a result of measuring discharge capacities of lithium air batteries in Examples 1 to 3.

FIG. 6 is an SEM analysis result for a cathode when the lithium air battery in Example 1 is in a discharge state.

FIG. 7A is a result of measuring a relationship of a battery voltage and a specific capacity when charge and discharge are repeated by a capacity cut-off method of 1 mA/cm² in order to evaluate a lifespan of the lithium air battery in Example 1.

FIG. 7B is a result of measuring a relationship of a battery voltage and a cycle when charge and discharge are repeated by a capacity cut-off method of 1 mA/cm² in order to evaluate a lifespan of the lithium air battery in Example 1.

FIG. 8A is a result of measuring a relationship of a battery voltage and a specific capacity when charge and discharge are repeated by a capacity cut-off method of 5 mA/cm² in order to evaluate a lifespan of the lithium air battery in Example 1.

FIG. 8B is a result of measuring a relationship of a battery voltage and a cycle when charge and discharge are repeated by a capacity cut-off method of 5 mA/cm² in order to evaluate a lifespan of the lithium air battery in Example 1.

FIG. 9A provides a photograph of an exemplary carbon foam having a thickness of 4 mm, as described in Example 1.

FIG. 9B provides a photograph of an exemplary carbon foam having a thickness of 2 mm, as described in Example 2.

FIG. 9C provides a photograph of an exemplary carbon foam having a thickness of 6 mm, as described in Example 3.

FIG. 9D provides a photograph of carbon foams having different thicknesses ranging from 880 μm to 6 mm.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail through exemplary embodiments. The exemplary embodiments of the present invention may be modified in various forms as long as the gist of the invention is not changed. However, the scope of the present invention is not limited to the following exemplary embodiments.

When it is determined that the description for the known configurations and functions may obscure the gist of the present invention, the description for the known configurations and functions will be omitted. In the present specification, the term “comprise” means that other constituent elements may be further included unless otherwise listed.

A lithium air battery is a battery system that uses lithium as an anode and using oxygen in the air as an active material in a cathode (an air electrode). In the anode, oxidation and reduction of lithium occur and in the cathode, oxidation and reduction of oxygen flowing from the outside occur.

Chemical Formulas 1 and 2 below represent reactions in the anode and the cathode when the lithium air battery is discharged.

(Anode): Li→Li⁺+e⁻ [Chemical Formula 1]

(Cathode): 2Li⁺+O₂+2e⁻→Li₂O₂ [Chemical Formula 2]

The lithium metal in the anode is oxidized to generate lithium ions and electrons. The lithium ions move to the cathode through an electrolyte and the electrons move to the cathode through a current collector and an external lead. Since the cathode is porous, external air may be introduced. The oxygen included in the external air is reduced by the electrons in the cathode and Li₂O₂ is formed as a discharge product.

A charge reaction proceeds reversely. That is, as in Chemical Formula 3 below, in the cathode, Li₂O₂ is decomposed to generate lithium ions and electrons.

(Cathode) Li₂O₂→2Li⁺+O₂+2e⁻ [Chemical Formula 3]

Major deterioration factors of the lithium air battery are as follows.

When the discharge product (Li₂O₂) reacts with carbon (C) as the cathode, an insulating layer (Li₂CO₃) is formed on the surface thereof and as a result, the transfer of the electrons is disturbed.

Li₂O₂+C→Li₂CO₃ [Chemical Formula 4]

The electrolyte is decomposed to form a byproduct and as a result, the transfer of the electrons or the transfer of lithium ions is disturbed.

The discharge product blocks the pores in the cathode to disturb the transfer of oxygen.

The present invention is characterized in that in order to prevent the transfer of oxygen from being disturbed when the discharge product blocks the pores in the cathode, the sizes of the pores in the cathode are increased and pores having different sizes are formed.

Hereinafter, the present invention will be described in more detail through detailed Examples. However, these Examples are to exemplify the present invention and the scope of the present invention is not limited thereto.

A cathode for a lithium air battery according to an exemplary embodiment of the present invention includes a carbon form consisting of a plurality of 3D open cells and having a net structure, an electrode material coated on a skeleton of the carbon foam and filled in the 3D open cells, and an air channel providing a space in which air introduced into the battery may flow.

Carbon Foam

The carbon foam is a kind of structure forming the frame of the cathode and provides a space in which the electrode material may be fixed into the cathode. The present invention is characterized in that the carbon foam is formed into a net structure constituted by the plurality of 3D open cells.

The shape of the 3D open cell is not particularly limited and may have any shape so long as the shape is a polyhedral shape capable of largely ensuring an empty space therein.

The porosity of the carbon foam may be about 10 pores per inch (PPI) to about 150 PPI, particularly about 10 PPI to about 120 PPI, and more particularly about 10 PPI to about 100 PPI. In various exemplary embodiments, the porosity of the carbon foam is about 10 PPI to about 150 PPI, about 10 PPI to about 120 PPI, about 10 PPI to about 100 PPI, about 10 PPI to about 90 PPI, about 20 PPI to about 150 PPI, about 20 PPI to about 120 PPI, about 20 PPI to about 100 PPI, about 40 PPI to about 150 PPI, about 40 PPI to about 120 PPI, about 40 PPI to about 100 PPI, about 50 PPI to about 150 PPI, about 50 PPI to about 120 PPI, about 50 PPI to about 100 PPI, and the like.

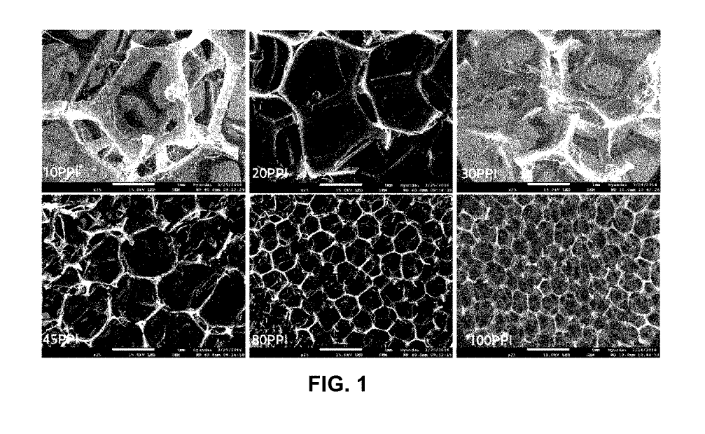

As illustrated in FIG. 1, when the carbon foam has a porosity of 10 PPI to 100 PPI, macro pores are formed inside the cathode. Accordingly, even though the electrode material is coated on the carbon foam, a large space is left and thus the discharge product may be evenly accumulated on the surface and the inside of the cathode, an air channel having a size enough to not disturb the flow of the air may be ensured, and a penetration rate of the electrolyte and/or the air may be improved.

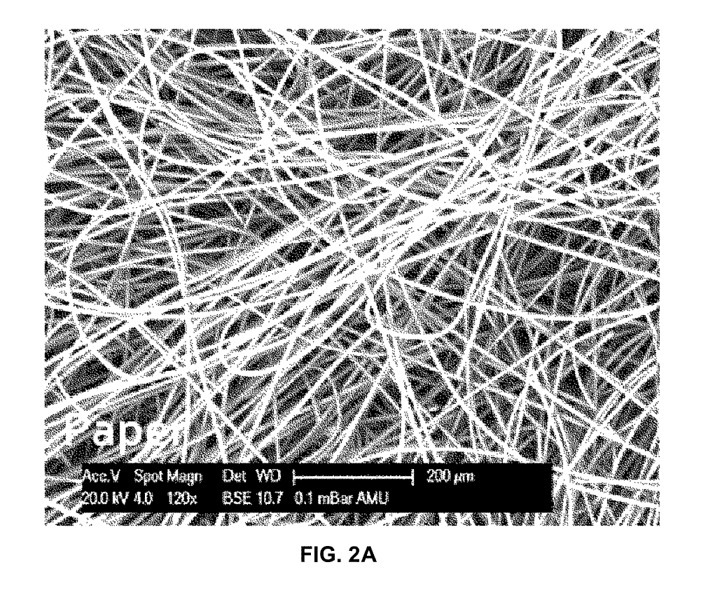

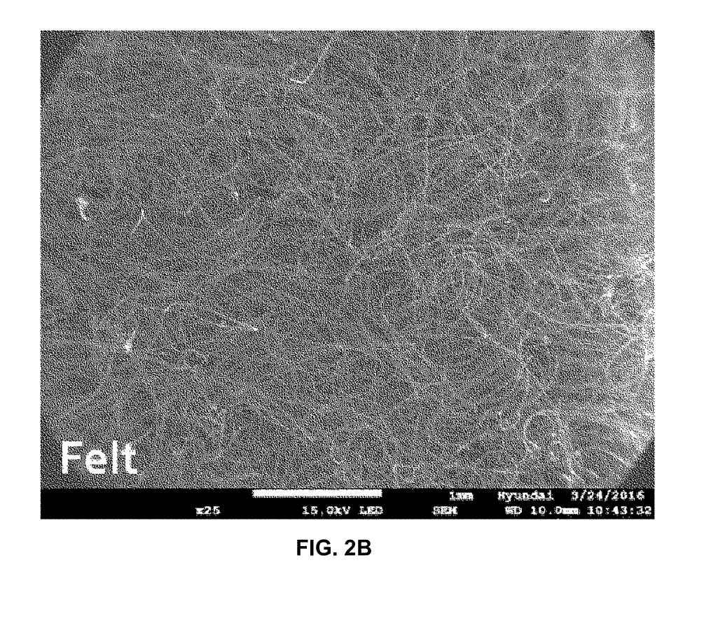

Since a lithium air battery in the related art uses a carbon paper illustrated in FIG. 2A and a carbon felt illustrated in FIG. 2B as a cathode structure, the macro pores are not present and thus it is difficult to form the discharge product therein.

A thickness of the carbon foam may be about 2 mm to about 6 mm, and particularly 2 mm to 4 mm. In order to improve a capacity per unit volume of the lithium air battery, the thickness of the carbon foam may be 6 mm or less, e.g., about 6 mm, about 5.5 mm, about 5 mm, about 4.5 mm, about 4 mm, about 3.5 mm, about 3 mm, about 2.5 mm, or about 2 mm.

Electrode Material

The electrode material may be a carbon-based material selected from the group consisting of graphite, carbon black, ketjen black, acetylene black, carbon nano tube (CNT), reduced graphene oxide (rGO), and a combination thereof.

The carbon-based material is a constituent element serving as a conductor which applies conductivity to the cathode and during the discharge of the battery, oxygen, lithium ions, and electrons flowing into the cathode react with one another on the carbon-based material to form a discharge product.

As the specific surface area of the carbon-based material is increased, it is advantageous that the above reaction occurs and thus the carbon-based material is coated on the skeleton of the carbon foam and may be provided in the internal space of the 3D open cells of the carbon foam.

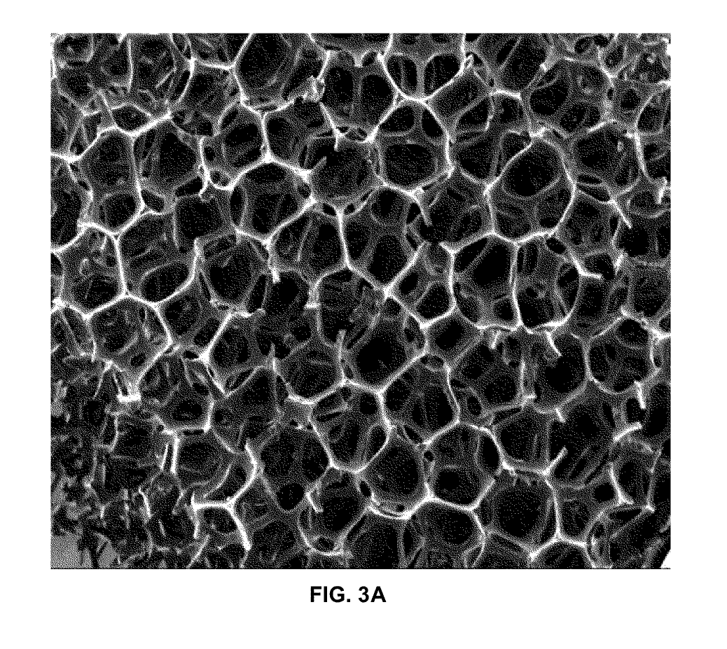

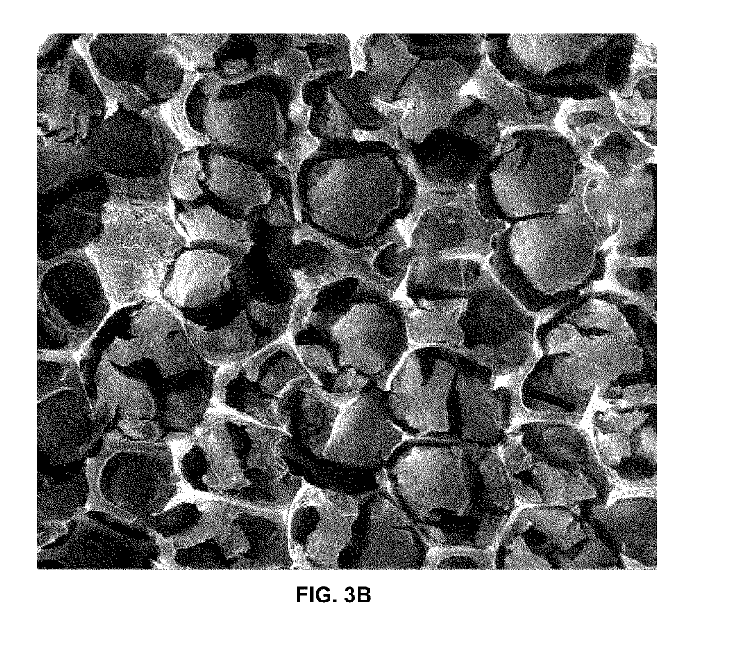

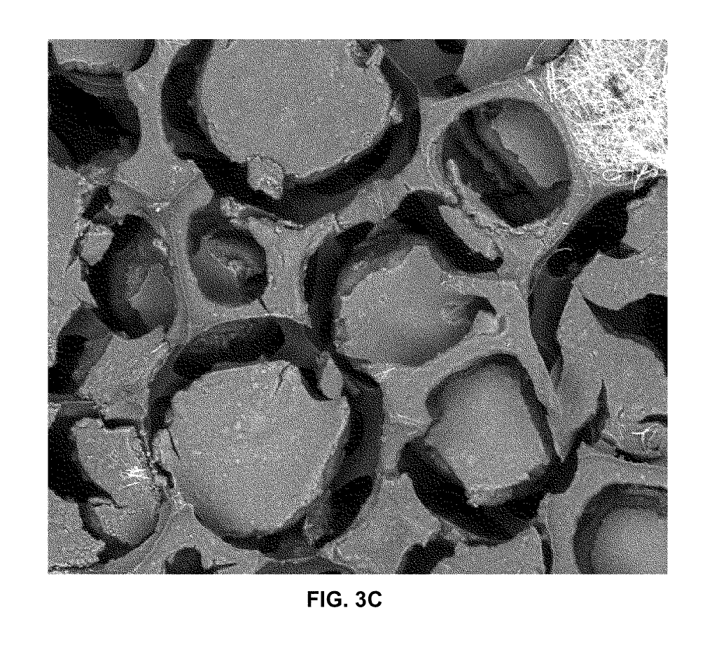

Particularly, the carbon-based material is impregnated into the carbon foam illustrated in FIG. 3A to form the cathode illustrated in FIG. 3B. Referring to FIG. 3B, it can be verified that the carbon-based material is filled even in the macro pores formed by the carbon foam as well as the skeleton of the carbon foam. Furthermore, referring to FIG. 3C, it can be seen that the carbon-based material is evenly coated on the skeleton of the carbon foam.

However, as illustrated in FIG. 3A, FIG. 3B, and FIG. 3C, since the carbon-based material is coated and provided to be filled in the macro pores formed by the carbon foam, if the amount of the carbon-based material is not appropriately controlled, the discharge product may not be formed in the cathode, but may be accumulated only on the surface. Furthermore, the air and/or the electrolyte may not be smoothly penetrated into the cathode.

Accordingly, the carbon-based material may be loaded with an amount of about 20 mg/cm³ to about 60 mg/cm³, specifically about 20 mg/cm³ to about 45 mg/cm³ when a porosity of the carbon foam is about 10 PPI to about 100 PPI and a thickness is about 2 mm to about 6 mm. When the amount of the carbon-based material is about 20 mg/cm³ or more, the carbon-based material is evenly coated and provided on the carbon foam and thus the specific surface area may be increased. When the amount of the carbon-based material is about 60 mg/cm³ or less, a space in which the discharge product may be formed in the macro pores formed by the carbon foam and a space in which the air and/or the electrolyte may penetrate may be ensured.

The carbon-based material may be evenly distributed to be about 0.032 mg per pore to about 0.081 mg per pore (e.g., about 0.32 mg per pore, about 0.32 mg per pore, about 0.32 mg per pore, about 0.34 mg per pore, about 0.36 mg per pore, about 0.38 mg per pore, about 0.40 mg per pore, about 0.42 mg per pore, about 0.44 mg per pore, about 0.46 mg per pore, about 0.48 mg per pore, about 0.50 mg per pore, about 0.52 mg per pore, about 0.54 mg per pore, about 0.56 mg per pore, about 0.58 mg per pore, about 0.60 mg per pore, about 0.52 mg per pore, about 0.54 mg per pore, about 0.56 mg per pore, about 0.58 mg per pore, about 0.70 mg per pore, about 0.71 mg per pore, about 0.73 mg per pore, about 0.75 mg per pore, about 0.77 mg per pore about 0.80 mg per pore, or about 0.82 mg per pore) of the carbon foam. When the carbon-based material is coated and provided only on a specific portion of the carbon foam, performance of the battery may deteriorate. Accordingly, the carbon-based material is coated on the carbon foam through an impregnation method and the carbon foam may have a porosity of about 10 PPI to about 100 PPI (e.g., about 10 PPI, about 15 PPI, about 20 PPI, about 25 PPI, about 30 PPI, about 35 PPI, about 40 PPI, about 45 PPI, about 50 PPI, about 55 PPI, about 60 PPI, about 65 PPI, about 7020 PPI, about 75 PPI, about 80 PPI, about 85 PPI, about 90 PPI, about 95 PPI, or about 100 PPI).

The electrode material may further include a catalyst other than the carbon-based material. The catalyst may be a catalyst accelerating the decomposition of the discharge product, a catalyst accelerating the formation of the discharge product, or a combination thereof. Particularly, the catalyst may be selected from the group consisting of MnO₂, Co₃O₄, Ru, Ir, RuO₂, Pd, Pt, Bi, Au, Pt₃Co, Ag, FeO, ruthenium supported on reduced graphene oxide (Ru-rGO), ruthenium oxide supported on reduced graphene oxide (RuO₂-rGO), iridium supported on reduced graphene oxide (Ir-rGO), Pt₃Co supported on reduced graphene oxide (Pt₃Co-rGO), FeCo supported on carbon nanotube (FeCo-CNT), FePt supported on carbon nanotube and reduced graphene oxide (FePtCNT/rGO), RuCo supported on carbon nanotube and reduced graphene oxide (RuCo-CNT/rGO), Pd—Ir core-shell nanotube, AgIr, AuIr, and a combination thereof.

Cathode and Lithium Air Battery

The cathode may include a complex of the carbon foam and the electrode material and an air channel formed in the complex.

The air channel is a passage through which the air introduced into the battery from the outside may flow in the cathode and means an empty space between the electrode material coated on the skeleton of the carbon foam and the electrode material provided in the macro pores formed by the carbon foam as illustrated in FIG. 3C.

The size of the air channel may be may be about 127 μm to about 1,270 μm (e.g., about 127 μm to about 1,270 μm, about 150 μm to about 1,270 μm, about 200 μm to about 1,270 μm, about 227 μm to about 1,270 μm, about 327 μm to about 1,270 μm, about 427 μm to about 1,270 μm, about 527 μm to about 1,270 μm, about 627 μm to about 1,270 μm, about 700 μm to about 1,270 μm, about 800 μm to about 1,270 μm, about 900 μm to about 1,270 μm, about 127 μm to about 1,100 μm, about 127 μm to about 1,000 μm, about 127 μm to about 900 μm, about 127 μm to about 900 μm, about 127 μm to about 800 μm, about 127 μm to about 700 μm, about 127 μm to about 600 μm, or about 127 μm to about 500 μm) after the electrode material is loaded on the carbon foam.

As described above, the present invention is characterized in that the air channel is ensured as a size of about 127 μm to about 1,270 μm by appropriately adjusting the porosity of the carbon foam and the amount of the electrode material (carbon-based material). And thus even though the discharge product is formed in the cathode, the flow of the air is not prevented and the penetration rate of the air and/or the electrolyte is improved.

The size of the air channel may mean a diameter when it is assumed that the air channel is a virtual cylinder formed in the cathode and mean a distance between the electrode material coated on the skeleton of the carbon foam and the electrode material provided in the macro pores formed by the carbon foam.

The lithium air battery according to an exemplary embodiment of the present invention may include the cathode including the carbon foam, the electrode material, and the air channel, the anode, and the electrolyte impregnated into the cathode and the anode.

The lithium air battery according to an exemplary embodiment of the present invention includes a cathode, a lithium anode, a separation membrane interposed between the cathode and the lithium anode, and an anode current collector.

Hereinafter, the present invention will be described in more detail through detailed Examples. However, these Examples are to exemplify the present invention and the scope of the present invention is not limited thereto.

### EXAMPLES

The following examples illustrate the invention and are not intended to limit the same.

### Example 1

Preparation of Cathode

Ketjen black (Lion Corporation in Japan, KB600J) was used as an electrode material and injected in to N-methylpyrrolidone (NMP) as a dispersed solvent together with a PVP-based dispersant capable of improving dispersion stability of the electrode material to prepare slurry. The slurry was impregnated in the carbon foam and dried for 12 hrs in a vacuum oven at 110° C.

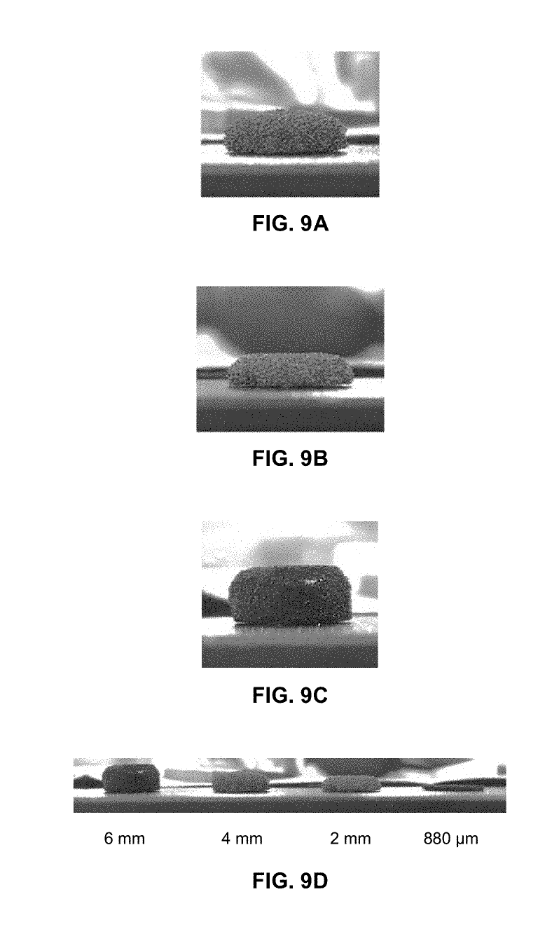

As the carbon foam, a carbon foam having a porosity of 80 PPI and a thickness of 4 mm was used so that the amount of the electrode material was 42.23 mg/cm³. See FIGS. 9A and 9D

FIG. 3A is a scanning electron microscope (SEM) analysis result for the carbon foam before the electrode material was coated and provided and FIGS. 3B and 3C are SEM analysis results of the cathode prepared by the above configuration and method. Referring to this, it can be verified that the electrode material is evenly distributed in the skeleton and the pores of the carbon foam.

Manufacture of Lithium Air Battery

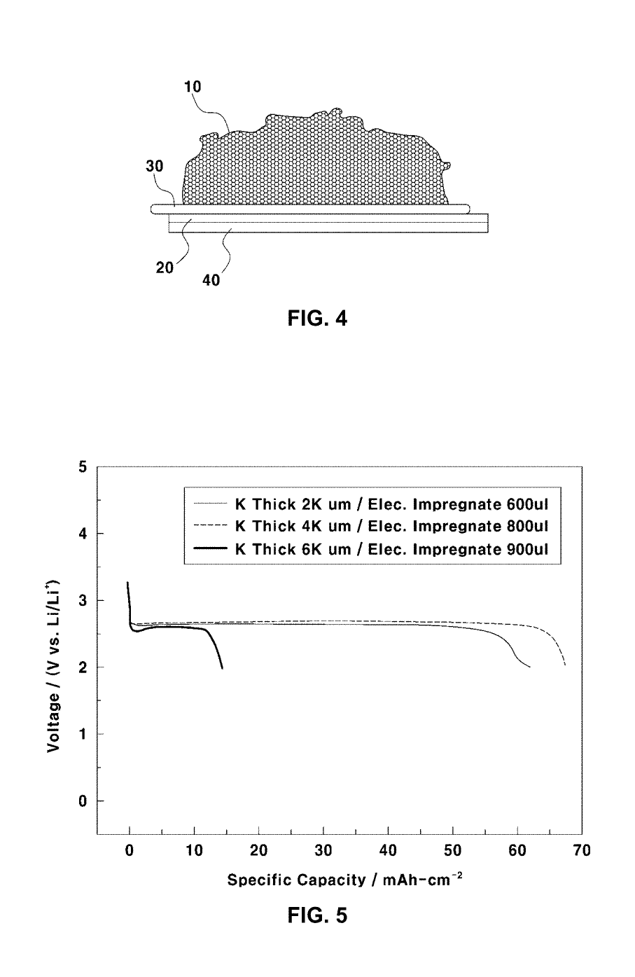

As an anode, lithium foil having a thickness of about 500 μm was used, as a separation membrane, a glass filter separation membrane was used, and as an anode current collector, a Sus Plate of 500 μm was used. As illustrated in FIG. 4, respective configurations were stacked in order of an anode current collector 40, a lithium anode 20, a separation membrane 30, and a cathode 10 from the lower side, 800 μl of diethylene glycol diethyl ether (DEGDEE) as an electrolyte was injected into the cathode and the anode, and then pressurized to form a coin-cell type lithium air battery.

### Example 2

Except for the following configurations, a lithium air battery was manufactured by the same configuration and method as Example 1.

When preparing the cathode, a carbon foam having a thickness of 2 mm was used so that the amount of the electrode material was 26.34 mg/cm³. See FIGS. 9B and 9D.

When manufacturing the lithium air battery, 600 μl of diethylene glycol diethyl ether as an electrolyte was injected.

### Example 3

Except for the following configurations, a lithium air battery was manufactured by the same configuration and method as Example 1.

When preparing the cathode, a carbon foam having a thickness of 6 mm was used so that the amount of the electrode material was 50.04 mg/cm³. See FIGS. 9C and 9D.

When manufacturing the lithium air battery, 900 μl of diethylene glycol diethyl ether (DEGDEE) as an electrolyte was injected.

### Test Example

### Test Example 1—Capacity of Lithium Air Battery

Discharge capacities of the lithium air batteries according to Examples 1 to 3 were measured. Furthermore, when the lithium air battery was in a discharged state, an SEM analysis for the cathode in Example 2 was performed together.

First, a discharge capacity when constant current of 0.25 mA/cm² was applied to the lithium air battery was measured, and the result was illustrated in FIG. 5.

Referring to FIG. 5, it can be seen that the lithium air battery in Example 1 has a high discharge capacity of about 68 mAh/cm², the lithium air battery in Example 2 has a high discharge capacity of about 62 mAh/cm², and the lithium air battery in Example 3 has a high discharge capacity of about 15 mAh/cm². In the case of the above-described Patent Document (Korean Patent Registration No. 10-1684015), when the discharge capacity was measured by the same method, a result that the discharge capacity was about 3.5 mAh/cm² was obtained, and thus in the lithium air battery of Example 1, the discharge capacity is about 19 times higher than that of the Patent Document.

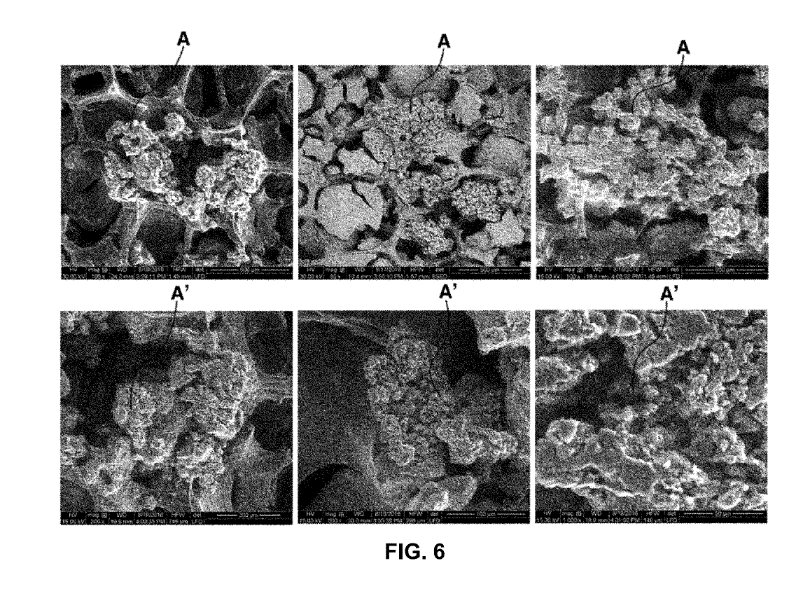

FIG. 6 is an SEM analysis result for a cathode when the lithium air battery in Example 1 is in a discharge state. Referring to FIG. 6, not only a discharge product A formed on the surface of the cathode but also a discharge product A′ formed in the cathode is observed.

Through the above result, in the cathode according to an exemplary embodiment of the present invention, it can be exactly seen that a retention amount of the discharge product is significantly increased and the flow of the air in the cathode is smooth.

### Test Example 2—Lifespan of Lithium Air Battery

Lifespan of Lithium Air Battery

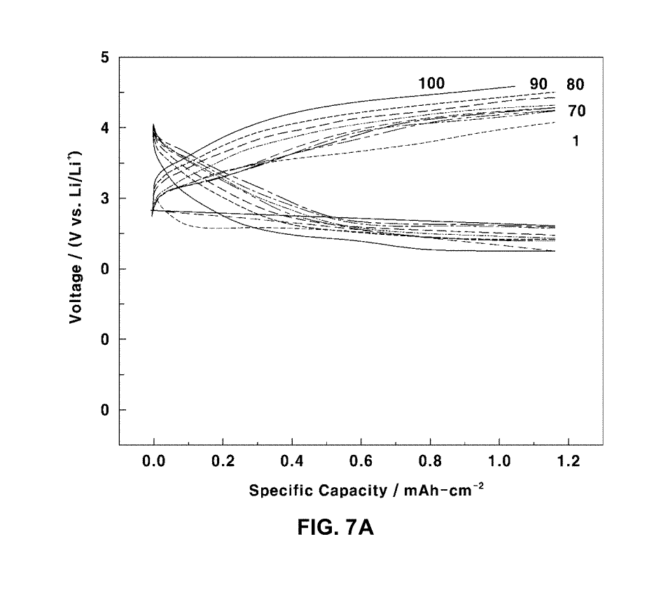

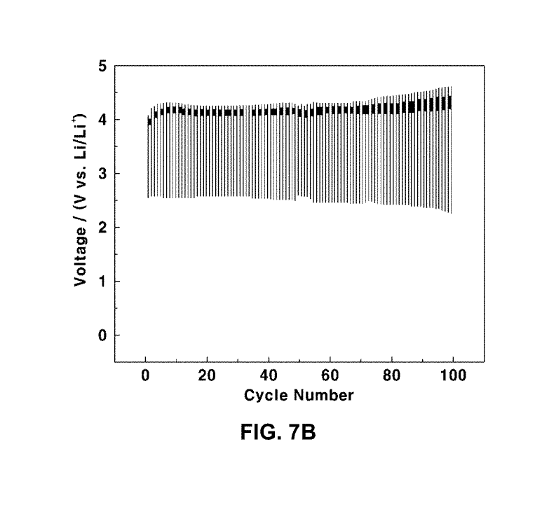

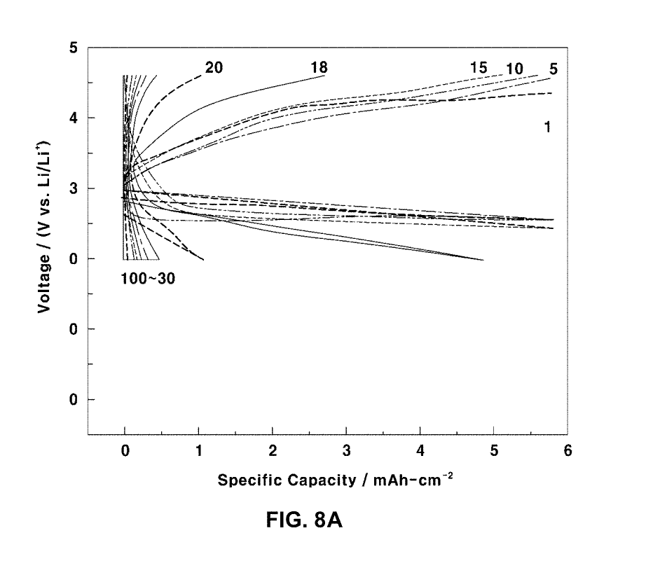

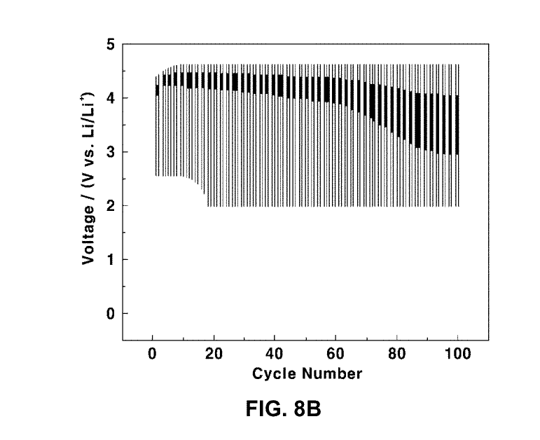

The lifespan of the lithium air battery in the Example 1 was measured. With respect to the lithium air battery, in a constant current-constant voltage charging (4.6V cut-off) section and a constant current discharge (2.0V cut-off) section of a current density of 0.25 mA/cm², charging and discharging were repeated by 1 mA/cm² and 5 mA/cm² capacity cut-off methods, respectively. The results were illustrated in FIGS. 7A, 7B, 8A, and 8B. For reference, the charging and discharging for the lithium air battery were performed once and represented by 1 cycle.

Referring to FIG. 7A, it can be seen that when the charging and discharging for the lithium air battery were performed by a 1 mA/cm² cut-off method, a battery voltage of 2.5 V or more is shown up to 100 cycles and there is no change in discharge capacity, and this means that reversibility of charge-discharge reaction is maintained up to 100 cycles. Furthermore, referring to FIG. 7B, it can be seen that when the charging and discharging for the lithium air battery were performed by a 1 mA/cm² cut-off method, a voltage gap is maintained up to 75 cycles and the voltage gap is slightly increased after 75 cycles.

Referring to FIG. 8A, when the charging and discharging for the lithium air battery were performed by a 5 mA/cm² cut-off method, a battery voltage of 2 V or more is shown up to 18 cycles and this means that reversibility of charge-discharge reaction is maintained. Furthermore, referring to FIG. 8B, it can be seen that when the charging and discharging for the lithium air battery were performed by a 5 mA/cm² cut-off method, a voltage gap is continuously increased, but the 5 mA/cm² cut-off is maintained up to 18 cycles.

As a result, it can be seen that in the lithium air battery according to an exemplary embodiment of the present invention, the charge reaction and the discharge reaction are smoothly performed in the cathode, and it is determined that the reason is that the flow of the air in the cathode and penetration of the air and/or the electrolyte into the cathode are facilitated.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cathode for a lithium air battery, comprising:
a carbon foam having a net structure configured by a plurality of 3D open cells;
an electrode material coated on a skeleton of the carbon foam and filled in the 3D open cells; and
an air channel providing a space such that air introduced into the battery flows.

2. The cathode for a lithium air battery of claim 1, wherein the carbon foam has a pores per inch (PPI) value in a range of from about 10 to about 100 PPI.

3. The cathode for a lithium air battery of claim 1, wherein the electrode material comprises a carbon-based material selected from the group consisting of graphite, carbon black, ketjen black, acetylene black, carbon nano tube (CNT), reduced graphene oxide (rGO), and a combination thereof.

4. The cathode for a lithium air battery of claim 1, wherein the electrode material further comprises a catalyst selected from the group consisting of MnO₂, Co₃O₄, Ru, Ir, RuO₂, Pd, Pt, Bi, Au, Pt₃Co, Ag, FeO, Ru-rGO, RuO₂-rGO, Ir-rGO, Pt₃Co-rGO, FeCo-CNT, FePt-CNT/rGO, RuCo-CNT/rGO, Pd—Ir core-shell nanotube, AgIr, AuIr, and a combination thereof.

5. The cathode for a lithium air battery of claim 1, wherein an amount of the electrode material is about 20 mg/cm³ to about 60 mg/cm³.

6. The cathode for a lithium air battery of claim 1, wherein a size of the air channel is about 127 μm to about 1,270 μm.

7. The cathode for a lithium air battery of claim 1, wherein a thickness of the cathode is about 2 mm to about 6 mm.

8. A lithium air battery, comprising:
the cathode of claim 1;
an anode; and
an electrolyte impregnated in the cathode and the anode.
